(19) United States
(12) Patent Application Publication
(10) Pub. No.: US 2003/0083935 A1
(43) Pub. Date: May 1, 2003

(54) Prepaid subscription voucher

(75) Inventor: Edythe Dickson, New York, NY (US)

Correspondence Address: Finnegan, Henderson, Farabow,, Garrett & Dunner, L.L.P., 1300 I Street, N.W., Washington, DC, 20005-3315, US

(73) Assignee: Time, Inc.

(21) Appl. No.: 09/984,945

(22) Filed: Oct. 31, 2001

(51) Int. Cl. G06F 17/60

(52) U.S. Cl. 705/14

(57) ABSTRACT

A computer-implemented method is provided for initiating a subscription to a periodical. The method comprises the steps of: purchasing a subscription voucher, wherein the voucher includes a plurality of periodical titles and a single monetary value. The purchaser then selects one of the plurality of periodical titles and indicates a recipient of the periodical on the face of the voucher. Next, the purchase sends the voucher to a fulfillment service bureau that then initiates a subscription to the periodical for the recipient identified.

### BACKGROUND OF THE INVENTION

1. Field of the Invention

The present invention relates to a system for initiating a subscription to a periodical. More particularly, the invention relates to a method and apparatus for facilitating the sale and fulfillment of a subscription through retail channels.

2. Related Art

Each year, over one billion single-issue copies of magazines are sold through over 50,000 retail outlets in the United States. The cost of a single issue, or the “cover price,” is often two or three times higher than the pro rata price of a single issue through a subscription. Despite the higher prices, consumers are willing to purchase single issues from retail outlets because of convenience and timeliness.

Some consumers instead choose to purchase long-term subscriptions to periodicals. For example, if a consumer wishes to subscribe to a magazine, the consumer may purchase a single issue at a retail outlet and mail back a “blow-in” or “bind-in” card enclosed in the magazine issue. Publishers place blow-in subscription cards by loosely inserting the cards into periodicals, such as magazines, by air injection. Publishers insert bind-in cards into the periodicals by, for example, binding subscription cards into issues during the printing process. Publishers use these methods to sell subscriptions because it conveniently gives them access to consumers that have already expressed an interest in their periodical.

Still other consumers prefer obtaining magazine subscriptions through third-party vendors, such as those made by Publisher's Clearing House (PCH). In this case, PCH (the offeror) uses the concept of a base card or sheet to which the subscriber affixes stamps corresponding to the magazine subscriptions purchased. The affixing of these stamps, however, does not create a voucher having any retail product redemption value. It is only a convenient, clever way of identifying a choice of magazine subscriptions. The same result could be achieved by writing the desired magazine choices on an order blank.

Despite the fact that there are several different methods for purchasing magazine subscriptions, many inconveniences arise from the traditional methodologies, which do not promote, and in fact hinder, customers from subscribing to the periodicals.

For example, payment under the traditional subscription method constitutes an inconvenience for the consumer because the only way to enclose payment with a blow-in or bind-in subscription card requires that the consumer enclose the card and payment in an envelope with accompanying postage. Even if a toll-free number is provided for initiating the subscription, the call itself inconveniences the consumer. Furthermore, if payment is not made at the time of ordering, a two-step process is required: first, the submission of the blow-in or bind-in card, and second, the payment of a bill. This two-step ordering process is not only inefficient but also wastes the consumer's valuable time. In paying the bill, the consumer must again correspond with the magazine publisher, paying an invoice by check and returning the payment by mail. Due to processing and delivery delays, the consumer may even receive multiple invoices of the bill, even though payment has already been made. These incidents of inefficiency not only inconvenience the consumer and increase the costs and efforts of the magazine publisher, but also jeopardize the goodwill of the magazine in the consumer's mind.

Another inconvenience for the consumer relates to the inability of the consumer to give a gift of a magazine subscription to another person and allow the recipient to pick the magazine. Today, a person can give any magazine subscription to anybody. Unfortunately, the specific magazine must be selected prior to giving the gift subscription to the recipient.

The prior art describes several attempts to address the inconveniences surrounding the traditional subscription methodologies. One attempt involved the retail sale of subscriptions at bookstores. The subscriptions were offered as part of a shelf-displayed package placed on a hook. The consumer could purchase one of the packages and subscribe to a periodical by paying for the package at the retail point-of-sale and then sending the pre-paid subscription activation card to the fulfillment house. Still another attempt incorporated the sale of subscriptions at specialty subscription kiosks. These kiosks comprised a computer system utilizing touchscreen technology to enable consumers to select and purchase either a subscription or a gift subscription. The customer could pay for either type of subscription at the kiosk by credit card, and the kiosk would issue a receipt for the transaction. For gift subscriptions, the subscription kiosk would also dispense a gift card.

None of these prior art methods completely solved the inconveniences of the traditional subscription methodologies. Significantly, the consumer never had the opportunity to purchase a voucher for at least one of a plurality of subscriptions listed on the face of the voucher and then on a later date, select the periodical for which a subscription is desired. Indeed, whether or not these prior art methods were transmitted through a processing center, they all comprised invoice orders for the initiation of a simple subscription. As such, they all suffered at least one common inconvenience associated with the traditional subscription methodologies, namely, the inability to allow the recipient of a gift subscription to pick the magazine they would receive.

Thus, the traditional methodologies for obtaining subscriptions to periodicals give rise to unsatisfactory complications and inconveniences that discourage consumers from subscribing to the periodical. Accordingly, there is a need for a system that allows consumers to purchase a subscription without the associated inconveniences caused by traditional subscription methodologies.

### SUMMARY OF THE INVENTION

In accordance with the present invention, a method for initiating a subscription to a periodical is disclosed. The method comprises the steps of: purchasing a subscription voucher, wherein the voucher includes a plurality of periodical titles and a single monetary value. The purchaser then selects one of the plurality of periodical titles and indicates a recipient of the periodical on the face of the voucher. Next, the purchase sends the voucher to a fulfillment service bureau that then initiates a subscription to the periodical for the recipient identified.

In accordance with another aspect of the invention, a method for creating a voucher for initiating a subscription to a periodical is disclosed. The method comprises the steps of defining in a computer memory, a subscription voucher record having a field for specifying a plurality of periodical titles, a field for specifying a cost of the voucher, and a field for specifying a periodical subscriber. The periodical identification field is then loaded with at least two periodical titles, and the face value field is loaded with a single monetary value. A voucher containing the loaded information is created and provided to a customer upon payment of the monetary value.

The foregoing has outlined some of the more pertinent aspects and features of the present invention. These aspects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description.

### BRIEF DESCRIPTION OF THE DRAWINGS

FIG. 1 is a block diagram of a network in which the present invention can be implemented;

FIG. 2 is a block diagram of a Point-of-Sale (POS) terminal upon which an embodiment of the present invention can be implemented;

FIG. 3 is a block diagram of a POS controller upon which an embodiment of the present invention can be implemented;

FIG. 4 is a block diagram of a Service Bureau terminal upon which an embodiment of the present invention can be implemented;

FIG. 5 is a depiction of a sample subscription voucher upon which an embodiment of the present invention can be implemented;

FIG. 6 is a detailed flow diagram of the steps performed by one embodiment of the present invention to create a voucher;

FIG. 7 is a representation of several sample voucher configurations; and

FIG. 8 is a detailed flow diagram of the steps performed by one embodiment of the present invention to transact a subscription order using a subscription voucher.

### DETAILED DESCRIPTION OF THE INVENTION

In the following detailed description, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that algorithmic changes may be made without departing from the scope of the present invention. The following detailed description is, therefore, not to be taken in a limited sense.

Turning first to the nomenclature of the specification, the detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU, and the maintenance of these bits within data structures reside in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc., which are often associated with manual operations performed by a human operator. It must be understood that no such involvement of a human operator is necessary or even desirable in the present invention. The operations described herein are machine operations performed in conjunction with a human operator or user who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, work stations, or personal computers are connected via communication links of various types. In a client server arrangement, programs and data, many in the form of objects, are made available by various members of the system.

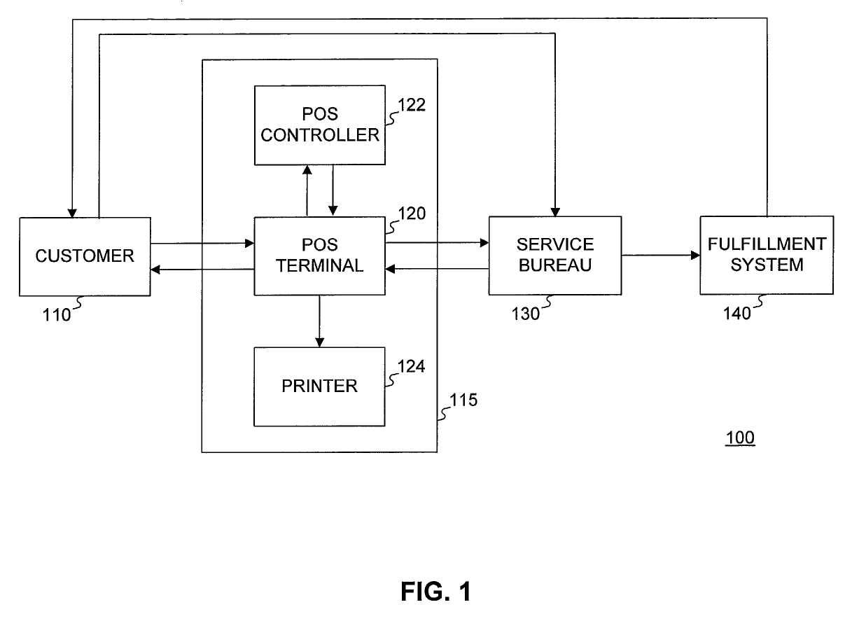

Referring now to the drawings, in which like numerals represent like elements throughout the several figures, the present invention will be described. FIG. 1 shows the present system in accordance with one embodiment. In this embodiment, system 100 includes a customer 110, a retail site 115, a service bureau 130 and a fulfillment house 140. Retail site 115 is further comprised of a POS terminal 120, a POS controller 122 and a printer 124. Customer 110, who is preferably a consumer planning to purchase a subscription to a periodical, transacts with a cashier at POS terminal 120 to purchase a voucher. Cashier at POS terminal 120 transacts with service bureau 130, that in turn, transacts with customer 110 and fulfillment house 140 to identify, and satisfy the customer's request. Fulfillment house 140 comprises a conventional fulfillment house for receiving subscription orders and filling them by distributing (e.g., via mail) issues of periodicals. In another embodiment, customer 110 may interact with POS terminal 120 directly or via a Web page operated by retail site 115. System 100 may have other components, as well, but these are not shown to facilitate description of the unique aspects of this embodiment of the invention.

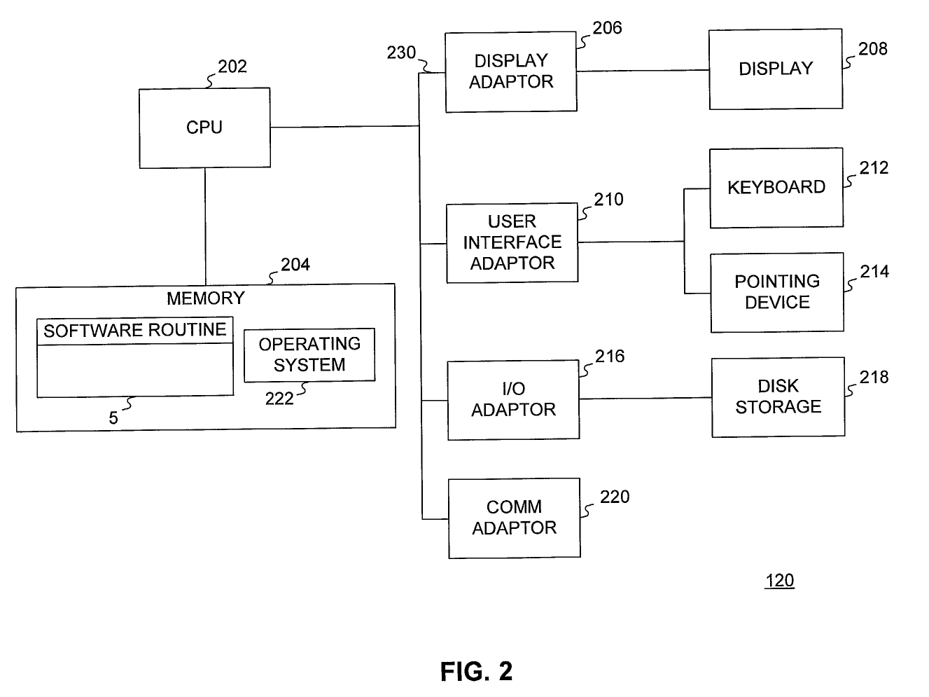

FIG. 2 shows a detailed block diagram of a POS terminal 120 that may be used to host and operate the present invention. POS terminal 120 as shown in FIG. 2 is comprised of a central processor unit (CPU) 202, a memory 204, a display adapter 206, a display 208, a user interface (UI) adapter 210, a pointing device 214, a keyboard 212, an input/output (IO) adapter 216, a disk storage unit 218, and a communications adapter 220 for providing a communications function. Memory 204 includes an operating system 222 for operating the device and a software routine 5 for computing payment amounts and contacting remote credit databases when authorization of consumer purchases is necessary. The various components of each POS terminal 120 communicate through a system bus 230 or similar architecture. As shown in FIG. 2, display adaptor 206 is coupled to display 208, user interface adaptor 210 is coupled to pointing device 214 and keyboard 212, I/O adaptor 216 is coupled to disk storage unit 218 and communications adaptor 220 is coupled to a network interface cable for providing connectivity between POS terminal 120 and a Public Switched Telephone Network (PSTN) interface for connectivity to an external computer network. Display 208 comprises a video driver adapted to send signals to a screen capable of displaying either text or graphics under the control of CPU 202. Display 208 is preferably large enough to display information relating to general sales and magazine voucher sales to the cashier or customer 110. Communication adaptor 220 links CPU 202 with other POS devices, such as printer 124 and POS controller 122. Printer 124 comprises a conventional printer suitable for printing various paperwork, such as subscription vouchers, in accordance with instructions from CPU 202.

In one embodiment, each POS terminal 120 includes a personal computer. In another embodiment, POS terminal 120 may be a high capacity information server. POS terminal 120 may have other components, as well, but these are not shown to facilitate description of the unique aspects of this embodiment of the invention. The hardware arrangement of this device, as well as other components discussed in this specification is intentionally shown as general, and is meant to represent a broad variety of architectures, which depend on the particular device used.

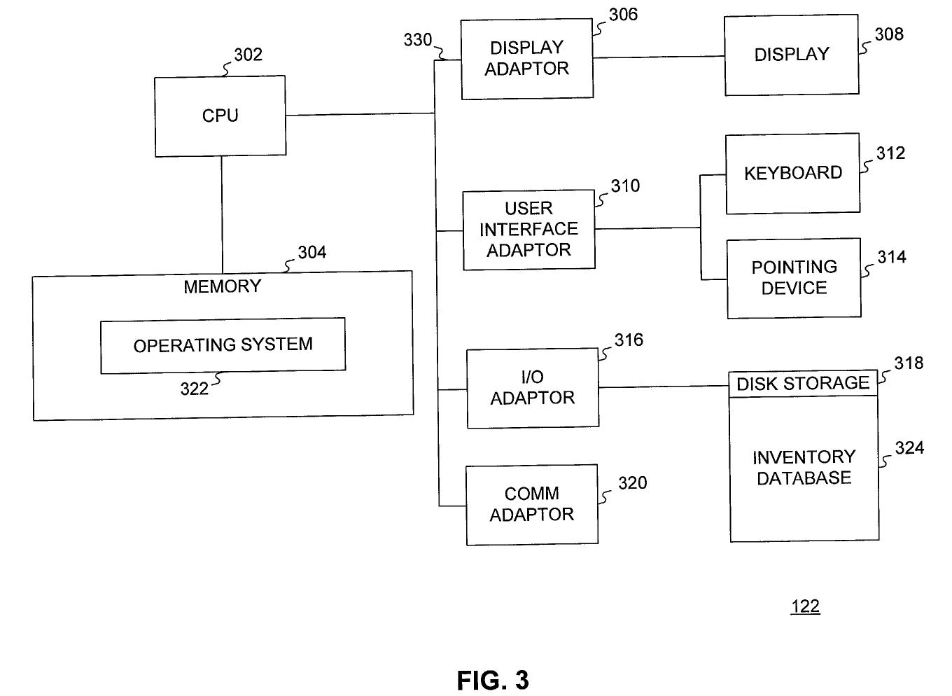

FIG. 3 illustrates one embodiment of POS controller 122 used in system 100. POS controller 122 preferably comprises a server equipped with conventional hardware, including CPU 302, memory 304, disk storage 318, and communications adaptor 320. Disk storage 318 contains an inventory database 324 of items offered for sale at retail site 115. Because POS controller 122 may interface with one or more POS terminals 120, communications adaptor 320 is preferably capable of interfacing with other POS terminals 120 via a plurality of high speed data lines. Other elements of POS controller 122 common to POS terminal 120 preferably operate in substantially the same manner as described above.

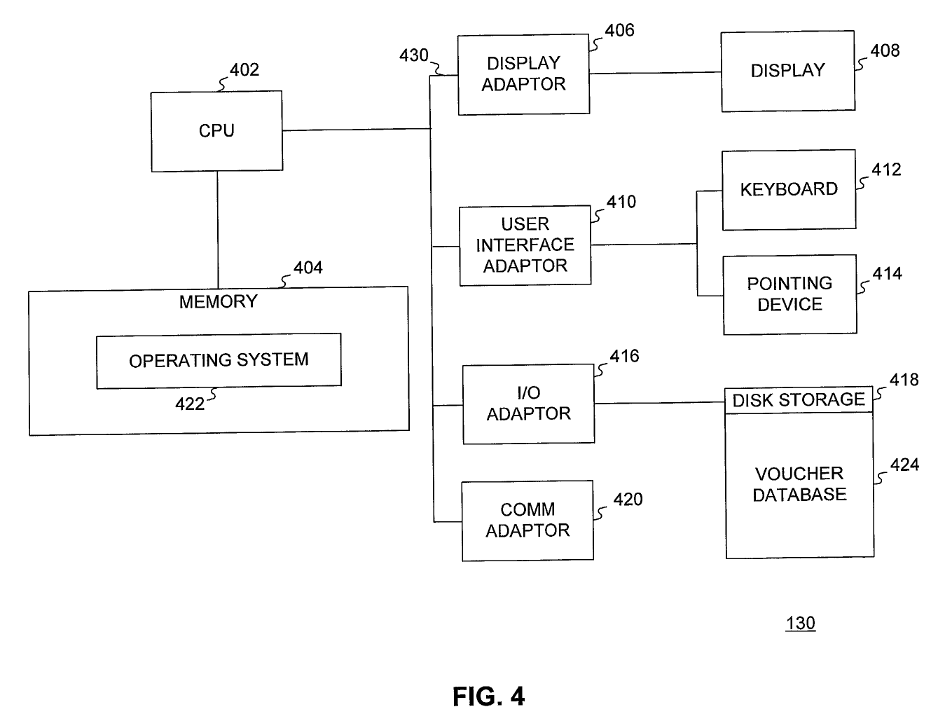

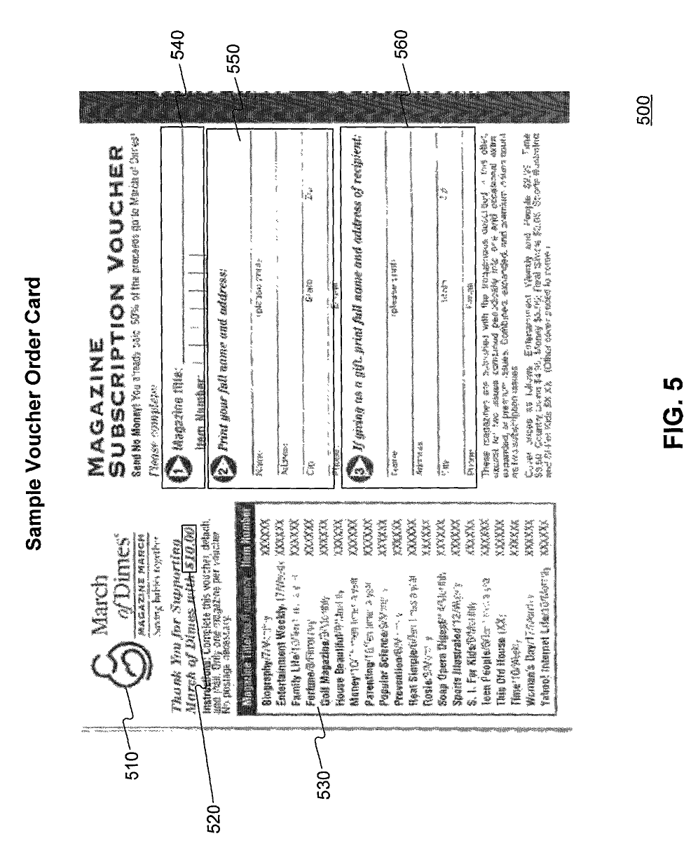

FIG. 4 illustrates one embodiment of Service Bureau 130 used in system 100. Service Bureau 130, like POS controller 122, preferably comprises a server equipped with conventional hardware, including CPU 402, memory 404, disk storage 418, and communications adaptor 420. As shown in FIG. 4, disk storage 418 contains a database 424 comprised of a plurality of different vouchers 500 (FIG. 5). Other elements of Service Bureau common to POS terminal 120 and POS controller 122 preferably operate in substantially the same manner as described above.

Referring now to FIG. 5, there is shown an example of a voucher 500 in accordance with one embodiment of the present invention. As shown in FIG. 5, each voucher 500 is comprised of a brand 510, a face value 520, a magazine list 530, a magazine selection field 540, a buyer data field 550, and a gift recipient data field 560. Brand 510 includes information such as a sponsoring institution's name, logo, and e-mail address. Face value 520 is a monetary value that represents the cost of voucher 500. Since voucher 500 is one item, it is sold at a single price. All magazines redeemed using voucher 500 are therefore valued at the same single price. In one embodiment, vouchers are valued at any price. In a second embodiment, vouchers are valued at a finite number of predetermined prices (e.g., $5.00, $10.00, $20.00, etc.) Magazine list 530 is a listing of the magazine titles available through voucher 500. Magazine list 530 includes a listing of the number of issues of each magazine to be delivered, the periodicity of each magazine (e.g., weekly, monthly, annually, etc.), and the item number for each magazine. Magazine selection field 540 is a user-inputted field that contains the buyer's selection from magazine list 530. Buyer data field 550 contains the name, address, phone number and email address of the buyer. Gift recipient data field 560 contains the name, address, phone number and email address of the recipient of the subscription. In one embodiment, voucher may have a single data field (instead of buyer data field and gift recipient data field) such that the name appearing on the face of voucher is always associated with the recipient of the subscription. Voucher 500 may also include instructions for completing/returning the voucher, required disclosures, and a serial number or other code for tracking and accounting purposes.

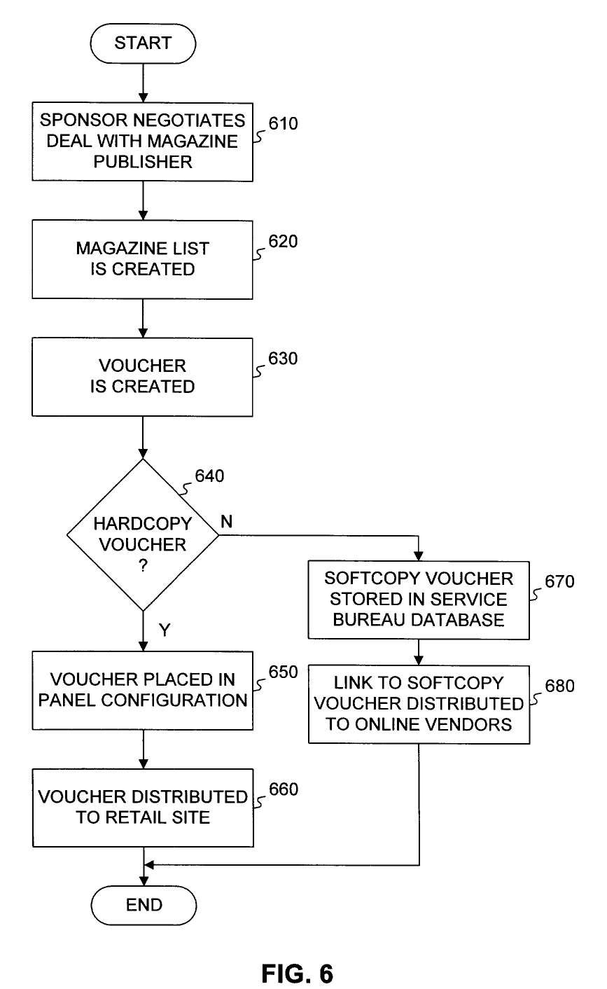

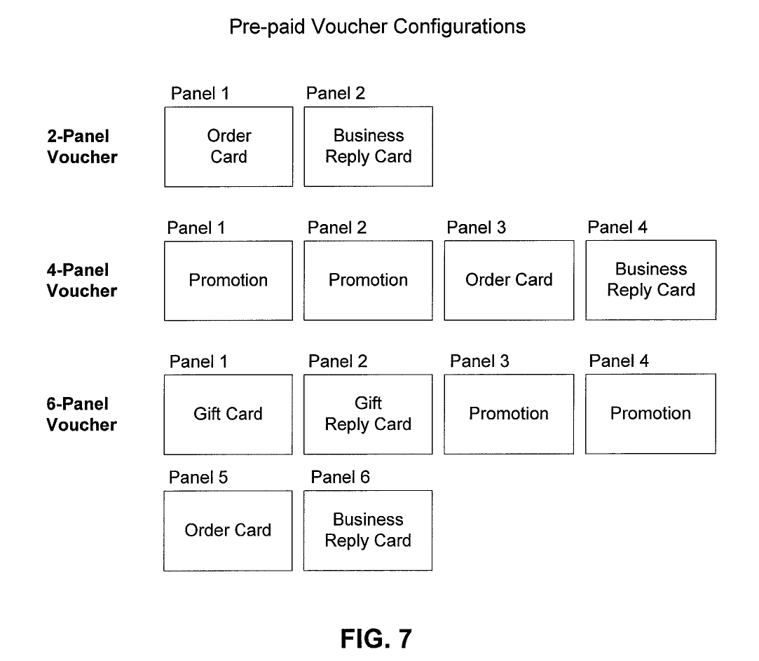

Referring now to FIG. 6, there is shown a detailed flow diagram depicting the steps performed by the present invention to create a voucher 500 for sale to customer 110. The process begins when a sponsor negotiates with a magazine publisher to include the publisher's magazine on the face of the sponsor's voucher (step 610). After several publishers agree to be included on the voucher, processing flows to step 620 where the magazine list 530 is created. Next, processing flows to step 630 where the voucher is created. In this step, the sponsor's brand 510, the face value 520, and magazine list 530 are added to a blank voucher 500. For purposes of this process, it is assumed that a blank voucher consists of a magazine selection field 540, a buyer data field 550, and a gift recipient data field 560 since those fields do not change from one voucher to the next. The newly created voucher is then stored in voucher database 424 in disk storage 418 of service bureau 130. After the voucher is created, processing flows to step 640 where the present invention determines whether the voucher to be created is a hardcopy or a softcopy (electronic) voucher. If the voucher to be created is a hardcopy voucher, processing flows to step 650 where the voucher is placed in a panel configuration. As shown in FIG. 7, vouchers in accordance with the present invention may be placed in 2-panel, 4-panel, and 6-panel configurations. The various panel configurations as shown permit the voucher to include several combinations of panels including: order card, a business reply card, promotion information, a gift card, and a gift reply card. Once the panel configuration is selected, processing flows to step 660 and the printed vouchers are distributed to one or more retail sites. If the voucher to be created is a softcopy voucher, processing flows to step 670 where the softcopy voucher is stored in database 424. A link to the softcopy voucher is then distributed to participating online vendors. Processing then terminates.

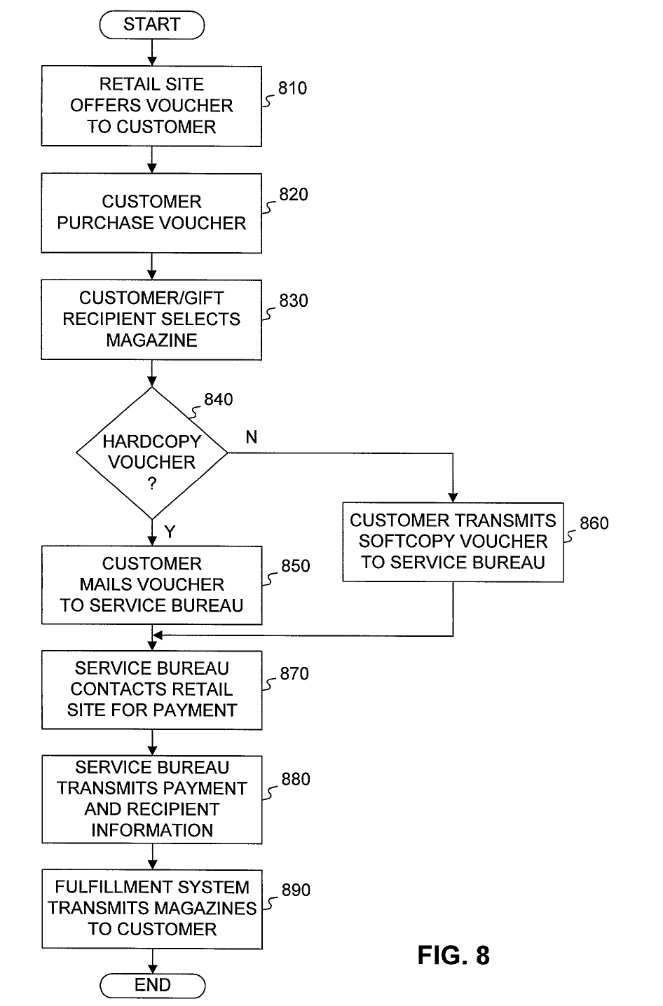

Referring to FIG. 8, there is shown a detailed flow diagram depicting the process performed when the present invention completes a transaction involving voucher 500. The process begins in step 810 when the retail site 115 offers a voucher to customer 110. The retail site 115 may either be an online Web site or it may be a “brick and mortar” retail site without departing from the spirit and scope of the present invention. Once the voucher has been offered to the customer, processing flows to step 820 where the customer purchases the voucher. If the voucher is a hardcopy voucher, the customer may be given the preprinted voucher at the time of purchase or the voucher may be printed by printer 124. If the voucher is a softcopy voucher, the customer may be given a password or other code that allows the customer or his/her designee to access the voucher online. Once a voucher has been purchased, POS terminal 120 transmits a signal to POS controller 122 to update inventory database 324 stored in disk storage 318 to reflect the sale of the voucher. POS terminal may also transmit a signal to service bureau 130, informing it of the sale. Service bureau 130 may then maintain a record of the sale to ensure that when a request for a subscription is received from a consumer (discussed below), the request corresponds to a properly transacted voucher. Returning to FIG. 8, it is shown that customer 10 or a gift recipient designated by customer 10 then selects one of the plurality of magazines listed on the magazine list 530 (step 830) and provides an address for delivery of the selected magazine. Processing then flows to step 840 where the present invention then determines whether the voucher is a hardcopy voucher or a softcopy voucher. For hardcopy vouchers, processing flows to step 850 and the customer mails the voucher to service bureau 130. Processing then flows to step 870. If the voucher is a softcopy voucher, processing flows to step 860 where the customer transmits the completed softcopy voucher to service bureau 130 for processing. Next, processing flows to step 870 where service bureau 130 contacts retail site (online or brick and mortar) for payment. Service bureau receives payment and then transmits it with the recipient information to fulfillment system 140. Fulfillment system, in step 890, then sends the selected magazine to the designated recipient. Processing then terminates. In another embodiment, once the customer purchases a softcopy voucher, the customer could be provided with a unique voucher identifier and a telephone number to call. The telephone number would enable the customer to speak with a human operator or an Interactive Voice Response (IVR) system to select a desired periodical and specify a delivery address. The operator or IVR system receiving the call would verify the caller's ID (using the unique voucher identifier or other private information), retrieve the appropriate voucher from memory, and then implement the caller's request. Since the magazine, length of subscription and designated address are all contained on voucher 500, an agent or operator at service bureau 130 would not be required to pre-process orders for fulfillment. Consequently, the delay previously seen in processing requests to initiate subscriptions would be significantly reduced.

From the foregoing description, it will be appreciated that the present invention provides an efficient system and method for reducing the computations necessary to re-render foreground and background objects. The present invention has been described in relation to particular embodiments which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

Although aspects of the present invention are described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the method of the present invention may conveniently be implemented in program modules that are based upon the flow charts in FIGS. 6 and 8. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems which may be used in practicing the instant invention and, therefore, no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit and scope. Accordingly, the scope of the present invention is defined by the appended claims rather than the foregoing description.

We claim:

1. A method of selling subscriptions to periodicals comprising the steps of:
printing a voucher including a fixed monetary value, a list of periodical titles a subscription to any one of which is available for the fixed monetary value and means for a subscriber to initiate a subscription to a title selected from the list;
selling the voucher; and
fulfilling the subscription to the selected title in response to a subscriber's use of the initiation means.

2. The method of claim 1 wherein the step of selling the voucher comprises selling the voucher to an intermediary organization at a discount off the fixed monetary value and the intermediary organization selling the voucher to a subscriber for the fixed monetary value.

3. The method of claim 2 wherein the intermediary organization is a charitable organization.

4. The method of claim 2 wherein the intermediary organization is a periodical distributor.

5. The method of claim 1 wherein the subscription initiation means comprises completing all required fields on the voucher and mailing the voucher to an address preprinted on the voucher.

6. The method of claim 1 wherein the subscription initiation means comprises calling a telephone number pre-printed on the voucher and providing the answering party with a unique code preprinted on the voucher, the title selection and subscriber identification.

7. A method of selling subscriptions to periodicals comprising the steps of:
buying a voucher having a fixed monetary value, a list of periodical titles a subscription to any one of which is available for the fixed monetary value and means for a subscriber to initiate a subscription to a title selected from the list; and
re-selling the voucher at the fixed monetary value.

8. A method of initiating a subscription to a periodical, the method comprising:
selecting a periodical title from a plurality of titles appearing on the face of a subscription voucher, said voucher further comprising a single monetary value;
transmitting the voucher to a fulfillment service bureau; and
initiating a subscription to the periodical for a recipient.

9. The method of claim 8, wherein the selecting step further includes the step of designating a person to receive the selected periodical.

10. The method of claim 8, wherein the transmitting step further includes the step of mailing the voucher to a fulfillment service bureau.

11. The method of claim 8, wherein the transmitting step further includes the step of transmitting a softcopy of the voucher to a computer terminal located at an online service bureau.

12. The method of claim 8, wherein the transmitting step further includes the step of verbally communicating selected information to an operator or IVR system.

13. A computer-implemented method for creating a voucher for initiating a subscription to a periodical, comprising:
defining in a first memory location, a subscription voucher record having a field for specifying a plurality of periodical titles, a field for specifying a cost of the voucher, and a field for specifying a periodical subscriber;
loading said periodical identification field with at least two periodical titles;
loading said face value field with a single monetary value; and
storing a completed voucher record in a second memory location.

14. The method of claim 13, wherein the storing step further comprises the step of storing the completed voucher as a multi-panel voucher.

15. The method of claim 14, wherein at least one panel is a promotion.

16. The method of claim 13 further comprising the step of providing the voucher to a customer upon payment of the monetary value.

17. The method of claim 13, wherein the providing step further includes the step of printing the voucher.

18. The method of claim 13, wherein the providing step further includes the step of providing the customer with a link to an electronic version of said voucher.

19. A method for initiating a subscription to a periodical through the use of a subscription voucher, the method comprising:
purchasing a subscription voucher, said subscription voucher comprising a single monetary value and a plurality of periodical titles with an associated number of issues;
selecting one of said plurality of periodical titles; and
transmitting the subscription voucher to a fulfillment service bureau;
wherein at least a portion of the monetary value is provided to the fulfillment service bureau in exchange for a subscription to the periodical for the associated number of issues.
